(19) United States
(12) Patent Application Publication
(10) Pub. No.: US 2010/0088520 A1
(43) Pub. Date: Apr. 8, 2010

(54) PROTOCOL FOR DETERMINING AVAILABILITY OF PEERS IN A PEER-TO-PEER STORAGE SYSTEM

(75) Inventors: Denis X. Charles, Redmond, WA (US); Siddhartha Puri, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/244,511

(22) Filed: Oct. 2, 2008

(51) Int. Cl. H04L 9/28; G06F 15/16

(52) U.S. Cl. 713/178; 709/219

(57) ABSTRACT

A method and system is provided for monitoring the availability of a peer in a P2P system that is used to provide remote storage or remote processing power. In one illustrative example, a recipient peer requests access to a service provisioned by another peer in a peer-to-peer network. The request may be a request to access a file or a file fragment that is being stored on the other peer. In order to make use of the accessed service, after receiving access to the service provisioned by the peer, the recipient peer needs to report to a central server that the service has been rendered. For instance, in some cases the file fragment accessed by the recipient peer may be encrypted, in which case the central server will send the recipient peer a decryption key after receiving the report that the service has been rendered.

### STATEMENT OF RELATED APPLICATIONS

This application is related to commonly assigned, copending U.S. patent application Ser. No. 11/768189, filed Jun. 25, 2007, entitled “Credit-Based Peer-to-Peer Storage”, U.S. patent application Ser. No. 12/123,688 (Microsoft Docket No. 321605.01), filed May 20, 2008, entitled “Protocol For Verifying Integrity Of Remote Data”, and U.S. patent application Ser. No. 12/123,979 (Microsoft Docket No. 321606.01), filed May 20, 2008, entitled “Security Architecture For Peer-To-Peer Storage System.” Each of the above applications is incorporated by reference herein in its entirety.

### BACKGROUND

Computer-readable data is traditionally stored on computer-readable media that is co-located with the computing device that most often accesses such data. For example, most personal computing devices comprise built-in hard drives and removable media drives such as optical drives which store the computer-readable data most often used by those computing devices. However, co-located computer-readable media is subject to the same physical environment as the computing device itself. Thus, physical damage to the computing device will also likely result in physical damage to the co-located computer-readable media and thereby possibly causing the loss of the computer-readable data.

To hedge against such physical damage, computer-readable data can be copied from co-located computer-readable media to remotely located computer-readable media, traditionally via a computer network. Such a “backup” process can provide protection of data in the event of localized physical damage. As computer networking hardware and infrastructure has improved, remote backups have become more popular, not only for critical corporate or business data, but also for personal data, such as digital photos and videos, and personal documents such as school assignments.

Because individuals often lack the necessary infrastructure to set up and maintain remote computer-readable storage media, a business model has emerged that provides access to remote computer-readable storage media to multiple individual consumers via common networking protocols and mechanisms, such as the ubiquitous World Wide Web (WWW). Traditionally, those offering such remote backup services to individual consumers maintain one or more data centers comprising the computer-readable storage media that is being used to remotely store the consumers' computer-readable data.

Paralleling improvements in networking hardware and infrastructure are improvements in the storage capacity of computer-readable media. Consequently, many individuals use computing devices equipped with co-located computer-readable media whose storage capacities far exceed the computer-readable data that the individual has to store thereon. Furthermore, such extra data storage space cannot be used by the individual to backup their own data, as the backup would then be subject to the same data-loosing impacts as the original data.

These improvements have led to the development of a centralized peer-to-peer (P2P) storage system, which involves a central server and a large number of user machines (peers). Such a system offers a service that allows users to store/retrieve data from the other peers. While the central server stores all location information of user data and is responsible for routing, most all of the data operations are handled by corresponding peers in a manner where the server does not store or receive any of the corresponded data. For example, a peer may wish to store data remotely. In this example, the peer can split a file into smaller data files, contact the server for facilitating routing decisions and then route the smaller data files to multiple peers (e.g., file 1 to peer 1, file 2 to peer 2, etc.).

Peers sign up for the service by providing a portion of their storage space to be used by the system. The provisioning of this space can be thought of as a payment made to system. In return for the provided space, the system provides the peer with some amount of reliable storage. For the probabilistic guarantee of retrieval of a file, it is important to accurately determine availability information of the peers, which may be defined as the proportion of time a peer is available and accessible online to the system.

One problem that arises when attempting to determine the availability information of the peers is that peers can behave in an adversarial fashion and try to report higher availability than their true availability. To counteract this malicious behavior, other peers can be asked to monitor a peer and report the availability of a peer. However, this is not a fully satisfactory solution since the monitoring peer could report false information.

### SUMMARY

A method and system is provided for monitoring the availability of a peer in a P2P system that is used to provide remote storage or remote processing power. In one illustrative example, a recipient peer requests access to a service provisioned by another peer in a peer-to-peer network. The request may be a request to access a file or a file fragment that is being stored on the other peer. In order to make use of the accessed service, after receiving access to the service provisioned by the peer, the recipient peer needs to report to a central server that the service has been rendered. For instance, in some cases the file fragment accessed by the recipient peer may be encrypted, in which case the central server will send the recipient peer a decryption key after receiving the report that the service has been rendered.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system that provides context for the described functionality;

FIGS. 2a and 2b are block diagrams of an exemplary system supporting remote storage;

FIG. 3 is a diagram of one method in which a peer or client downloads a file fragment from another peer.

FIG. 4 is a diagram of one method in which a central server authorizes a peer or client to upload or download a file fragment to or from another peer.

FIG. 5 is a diagram of one method in a peer or client uploads a file fragment from another peer.

### DETAILED DESCRIPTION

As described herein, a protocol reliably determines the availability of a peer in a P2P system even if the peer behaves in an adversarial fashion and try to report higher availability than their true availability. Such a protocol may be implemented in a P2P system that provides for sharing information, remote storage of information and remote backup of information. Further, an illustrative architecture acts to reward peers for (a) actual service rendered to each other, and (b) “availability,” i.e. readiness to render a service. One goal of the protocol is to measure (a) and (b) accurately with minimal server involvement and in such a way that no peer has an incentive to cheat.

An illustrative protocol consists of two parts. The first part ensures that only the actual service received by a recipient is reported to the system. During a single operation, a peer may receive services from hundreds of other peers. Server load is reduced by reporting the transaction only from the peer receiving the service. To remove the incentive for fraud, the service received by the peer is useless without a final key from the server. The peer can obtain the correct key only by accurately reporting the transaction.

The second part of the protocol ensures that a peer's availability is measured in terms of the actual service rendered. Rather than relying on self-reporting, availability is defined as the fraction of service requests to which a peer responds. If a peer does not have enough activity to measure availability, spurious activity which is indistinguishable from normal operation can be generated by the system.

An exemplary protocol can be implemented in a storage exchange P2P system. Such a storage exchange P2P system allows peers to back up their data on other peers' machines, for example, at a cost of providing some disk space for other peers to backup their data. Such a system may implement a policy such that after “sharing” 1.5 GB of hard drive space a peer is allowed to backup 1 GB of his personal files on one or more other peer machines. A storage exchange system can implement an exemplary protocol to ensure that each peer maintains an adequate level of availability in order to participate in the system.

For purposes of illustration only a P2P system will be described in which distributed remote storage is provided in accordance with a pay forward scheme, whereby credits earned for enabling others to store computer-readable data on computer-readable media co-located with a user's computing device enables that user to remotely store their own computer-readable data. In this example a conversion rate between the amount of storage offered by a user and the amount of storage credit provided in return can be adjusted to maintain balance within the overall remote storage system, rendering the system self-sustaining. The earned storage credit can be universally used, including enabling others to remotely store computer-readable data, either in association with the user who earned the storage credit, or independently. It should be emphasized however, that the protocols and techniques described herein may be applied in one or more other contexts that require distributed data access, data storage and the like, regardless of whether a pay forward scheme is employed.

The techniques described herein focus on, but are not limited to, the provision of storage credits in units of gigabyte-access-days, enabling access to a gigabyte of computer-readable storage capacity for one 24-hour period. Indeed, the quantum unit of storage credit can equally be a megabyte-access-day, a gigabyte-access-hour, or any other unit of storage per unit of time. Similarly, while the techniques below focus on storage credits, other computing resources that can be shared and distributed can equally utilize the described mechanisms. For example, the mechanisms described below can be identically applied to processing credits, which can be assigned based on the processing capability provided by a user, and which can subsequently enable that user, or whomever they transfer such credit to, to utilize remote processors for a period of time for the performance distributed computations.

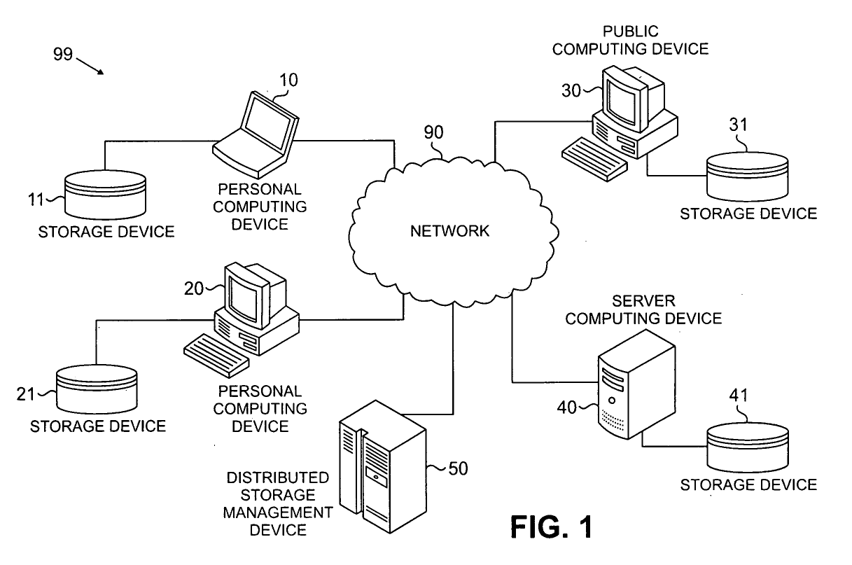

Turning to FIG. 1, an exemplary network system 99 is illustrated comprising the network 90 itself, personal computing devices 10 and 20, a public computing device 30, a server computing device 40, and a distributed storage management device 50, all connected to the network 90. Each of the computing devices 10, 20, 30 and 40 can comprise storage devices 11, 21, 31 and 41, respectively, that can be co-located with the computing devices. Examples of such co-located storage devices include both computer-readable storage media that is internal to a computing device case and computer-readable storage media that can be connected to the computing device via local cabling.

In one embodiment, some or all of the storage capacity of the storage devices 11, 21, 31 and 41 can be offered by the respective computing device 10, 20, 30 and 40 to the other computing devices connected to the network 90. Such a decision can be made by administrators of the computing devices 10, 20, 30 and 40, or, in multi-user environments, each user of the computing devices 10, 20, 30 and 40 can offer some or all of the storage capacity that is allocated to that user from the storage devices 11, 21, 31 and 41. Similarly, some or all of the processing capability of the computing devices 10, 20, 30 and 40 can be offered for use by other computing devices connected to the network 90.

A centralized server, such as the distributed storage management device 50, can receive offers to share storage space, processing capability, or other sharable computing resources from the computing devices 10, 20, 30 and 40 or, more precisely, from one or more users or administrators of those computing devices. The distributed storage management device 50 can maintain account information for each user and can credit each user's account an appropriate amount of credits given the amount of resources offered by the user, the length of time such resources were offered, the reliability of such resources, and like information. The amount of credits given based on such resources can be further influenced by a conversion factor that can be adjusted by the distributed storage management device 50 based, at least in part, on the balance within the system 99 between outstanding credits and offered, but unused, resources.

The distributed storage management device 50 can also match a peer computing device that seeks to use a distributed resource with a peer computing device that is offering such a resource for use. The distributed storage management device 50 can identify such peers to one another, thereby enabling peer-to-peer communication to implement the resource sharing. In one embodiment, the distributed storage management device 50 need not handle any shared data; instead, all such sharing can occur strictly between peers.

Although not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

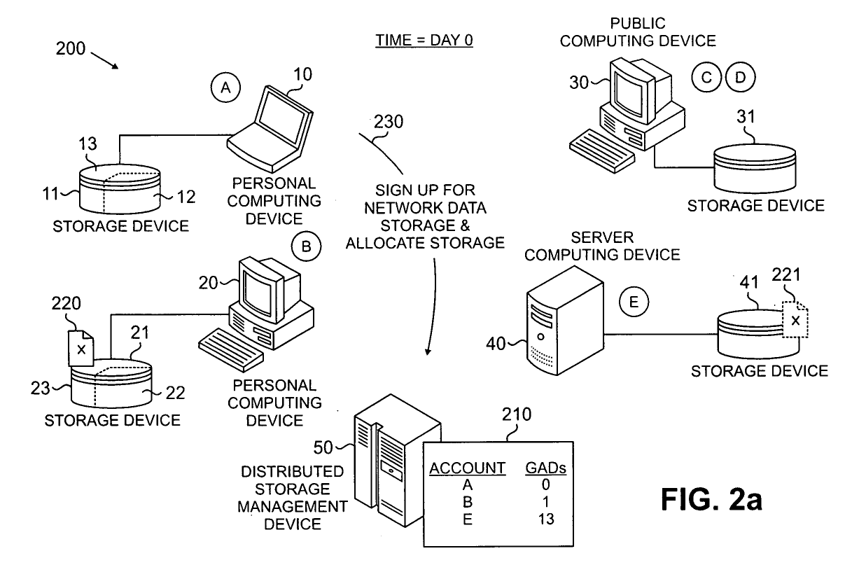

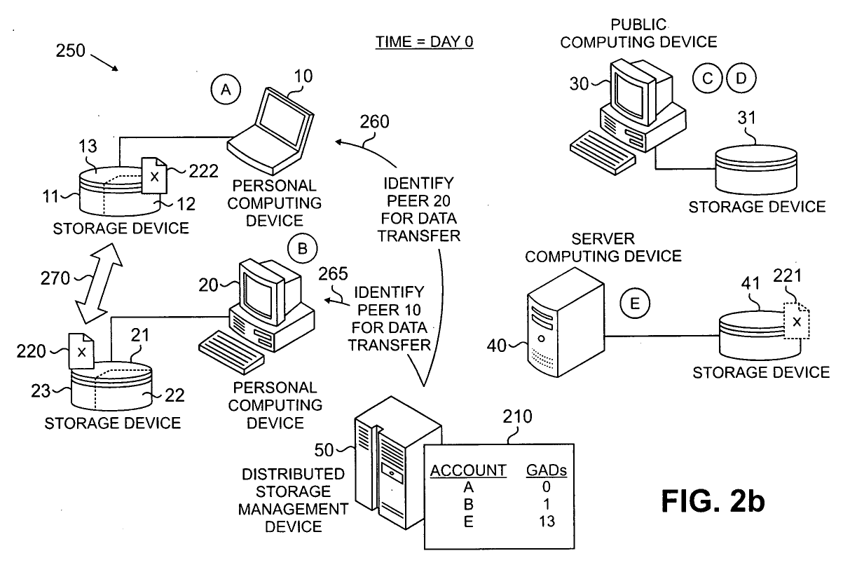

Turning to FIG. 2a, a system 200 is illustrated showing initiating steps for enabling a computing device to remotely store computer-readable data. The system 200 comprises the same elements as system 99 of FIG. 1, except that, while connections amongst the computing devices 10, 20, 30, 40 and 50, via the network 90, remain, they are not specifically illustrated for the sake of visual clarity. In addition, to provide context for the descriptions below, each of the computing devices 10, 20, 30 and 40 have been associated with one or more users. Specifically, as shown in FIG. 2a, personal computing devices 10 and 20 can be used by users “A” and “B”, respectively. The public computing device 30 can be used by multiple individuals, represented in the below descriptions are users “C” and “D”, and the server computing device 40 can be administered by a user “E”.

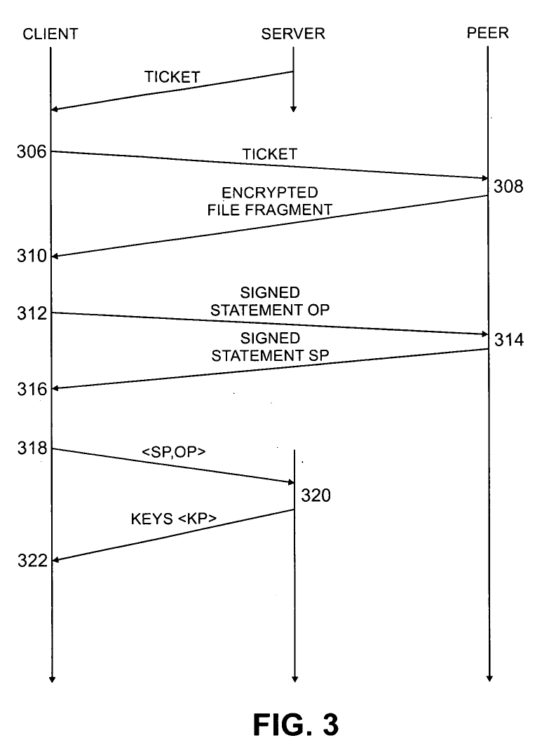

As indicated in FIG. 2a, the system 200 reflects a random initial time from which mechanisms for implementing a pre-earned credit-based resource sharing service can be analyzed. The illustrated indication in FIG. 2a is not meant to reflect an initial time for the overall system 200, but rather only for the descriptions below. For example, at the time illustrated in FIG. 3a, storage space on storage devices 21 and 41 can have already been offered, by users B and E, respectively to the distributed storage management device 50. The storage capacity offered is illustrated in FIG. 2 in the form of a shaded section of the hosting storage device. Thus, for example, storage device 21 comprises a shared section 22 and a private section 23 reserved for use with the personal computing device 20, to which the storage device 21 is connected. Similarly, storage device 41 is completely shaded, illustrating that a storage device can be entirely dedicated to hosting remotely stored data. As will be described further below, the shared storage capability 22 and 41 can have, by the time illustrated in FIG. 3a, earned both user B and user E credits.

The distributed storage management device 50 can maintain a database 210 whereby credits earned for sharing computing resources can be tracked with the account of the individual responsible for sharing those resources. Thus, as shown in FIG. 2a, the database 210 can comprise an account for user B and an account for user E, each having already earned at least one credit. The specific credits illustrated are Gigabyte-Access-Days (GADs), though the below descriptions are, in no way, limited only to such credits. A GAD, as suggested by its name, can define a particular amount of resource sharing; in this case, the sharing of a gigabyte of computing storage capability for one day. In the exemplary database illustrated in FIG. 2a, the GADs earned by user B can be less than those earned by user E because of the relative storage capability being offered for sharing by users B and E, respectively.

As will be described in further detail below, for a user to use whatever computing resources are being made available within the system 200, such a user can first be required to earn credits by themselves offering up, for sharing, resources from their own computing device. To offer shared resources, and thereby earn credits, a user, such as user A, can use a computing device, such as A's personal computing device 10, to offer shared resources to a management device, such as the distributed storage management device 50. Thus, as shown, a message 230 from the computing device 10 can request that the distributed storage management device 50 create a new entry in the database 210 reflecting the addition of the account of user A. Included with the message 230 can also be information regarding the amount of resources being shared, such as the amount of storage capacity being shared 12. And, in addition to sending message 230, the computing device 10 can also set aside the shared storage capacity 12 of the storage device 13, thereby separating it from the storage capacity 11 being retained for local access by the computing device.

Upon receipt of a notification of shared resources, such as message 230, the distributed storage management device 50 can create an appropriate account for the requesting user within the database 210. Thus, as illustrated in bold in FIG. 2a, a new account for user A can be created by the distributed storage management device 50. The distributed storage management device 50 can also identify one or more computing devices, such as computing device 20, that may have requested a shared resource, and can identify both the sharing and requesting computing devices to one another. For example, as shown in FIG. 2b, the distributed storage management device 50 can notify the computing device 10, via message 260, of the computing device 20 that may have requested the use of remote storage capacity. Similarly, via message 265, the distributed storage management device 50 can notify computing device 20 of the computing device 10 that has volunteered to host shared storage capacity 12.

In response to such messages from the distributed storage management device 50, client software on the computing devices 10 and 20 can initiate peer-to-peer communication 270 and can transfer data from the requesting computing device 20 to the sharing computing device 10. For example, in the exemplary system 250, the computing device 20 may comprise a locally stored file 220 that it seeks to backup remotely. Consequently, once it receives a message, such as message 265, client code on the computing device 20 can, transparently to the user B, transfer some or all of the data of the file 220 to the shared portion 12 offered by the computing device 10. File 222, and file 221 on storage device 41, are meant to represent some or all of file 220 which can be remotely stored in a secure and fault-tolerant manner.

In one embodiment, client software, such as on the computing device 20 that is remotely backing up the file 220, can encrypt the file 220 and can then divide the encrypted file into segments such that, even if some segments were to be lost, the encrypted file could be reconstructed and decrypted into file 220. Because other computing devices that offer shared storage, such as computing devices 10 and 40, would only have access to those components 222 and 221, respectively, of the file 220 that were stored on the storage devices 11 and 41, respectively, those other computing devices would not be able to recover the file 220, or gain unauthorized access to its contents. Furthermore, even if another computing device was able to reassemble file 220 from its remotely stored components, such a computing device would still not be able to access the contents of file 220 because it would lack the necessary decryptors.

Fault-tolerant encoding and storage schemes are well known to those skilled in the art, and the mechanisms herein described are not limited to, or require the use of, any particular scheme. In one embodiment, however, the well-known Reed-Solomon encoding scheme can be used to divide a file 220, after it has been encrypted, into components which can be stored remotely in multiple locations. The Reed-Solomon encoding scheme enables the reconstruction of the encrypted file from the components even if up to a predetermined maximum number of components are not available at the time the file 220 is requested by the computing device 20 from remote storage.

In practice, it is expected that the shared storage capacity, such as shared storage 12, 22 and 41, will comprise components of a myriad of files. To maximize the fault-tolerance of the system 250, the distributed storage management device 50 can apply various mechanisms to the initiation of peer-to-peer communication, such as peer-to-peer communication 270. For example, in one embodiment, peers can be identified to one another, such as via messages 260 and 265, based on a host of factors, including the physical location of the peers, the physical locations of other components of a remotely stored file, the operating system used by the peers, the bandwidth capabilities of the peers' connections to the network 90, and the reliability of the peers. By setting up peer-to-peer communications that can distribute components of a remotely stored file in a geographically diverse manner, the distributed storage management device 50 can provide further fault tolerance against regional disasters, such as a flood or earthquake. Similarly, by setting up peer-to-peer communications that can distribute components of a remotely stored file to computing devices utilizing diverse operating systems, the distributed storage management device 50 can provide further fault tolerance against malware, which generally is relevant only to the targeted operating system.

The distributed storage management device 50 can provide both short term and long term fault tolerance. For example, it can provide short term fault tolerance by dividing a file into components where the overall file can be reconstructed even if one or more of the components are on a computing device that is experiencing a temporary failure, such as due to a power outage, network outage, or merely the need for a software update. Similarly, the distributed storage management device 50 can provide for long term fault tolerance by dividing a file such that the file can be reconstructed even if one or more of the components are on a computing device that has experienced a permanent, or what appears to be a permanent loss of data, such as due to a hardware failure, regional disaster, or the deactivation of the computing device.

As previously mentioned, a protocol is provided to reliably determine the availability of a peer in the P2P system by ensuring that only the actual service received by a recipient is reported to the system and that a peer's availability is measured in terms of the actual service rendered. The protocol requires the recipient to report the successful delivery of a service between the recipient and an individual peer. In particular, the recipient must report the provisioning of the service to the server in order to make use of the service performed by the peer. For instance, if the service being delivered is a file or file fragment, the recipient will need to report the successful delivery of the service in order to receive a key from the server, which the recipient needs in order to decrypt the file or file fragment.

One way to implement such a protocol employs a challenge and response scheme that uses digital signatures. An example of such a protocol will now be provided. For clarity, the peer that receives the service, in this case delivery of a file fragment, will be referred to as the client.

FIG. 3 shows a series of transactions along a timeline in a P2P system such as the systems shown in FIGS. 1 and 2. In this example the client is downloading a file fragment from a peer. In a peer-server transaction, the server delivers a token or ticket T to the client authorizing the client to perform the series of transactions with the peer in order to obtain the file (event 302). The transaction terminates when the client receives the file (event 304). The client may be obtained the ticket from the server in any appropriate manner. That is, the manner in which the client obtains the ticket from the server is not relevant to the protocol described herein.

In a client-peer transaction, the client formulates a request for a file fragment and send it and the ticket T to the peer (event 306). The ticket serves as evidence that the process is authorized by the server. The peer, in turn, receives the request and responds by formulating an encryption of the file fragment, P_{E}, using the key K_{P}=Sign(T) where Sign(T) refers to the signature that is created using the private key of the peer on the message T (event 308). The client receives the encrypted file fragment P_{E} to complete the transaction (event 310).

In another client-peer transaction, the client computes a keyed hash function H(C, P_{E}) and sends H(C, P_{E}) and C in a message to the peer (event 312). This message is signed using the client's signature. This signed message will be referred to as the signed statement O_{P}. The peer receives the signed statement O_{P} verifies that H(C, P_{E}) is correct and returns a signed statement S_{P} to the client certifying this (event 314). The client receives the signed statement to complete the transaction (event 316).

The client repeats the transactions described above with other peers that are storing file fragments of the file being requested by the client. When the client has enough encrypted fragments to re-create file, he has obtained a set of statements or certificates <S_{P}, O_{P}>, which are submitted to the server (event 31 8). The server receives the set of statements or certificates <S_{P}, O_{P}> and responds by sending the client the list of keys <K_{P}> that can be used to de-crypt the files (event 320). The server can do this because the server maintains a database that includes the private keys of every peer in the system. The client uses the keys <K_{P}> to decrypt the file fragments (event 322). If after decrypting the fragments, the client finds a packet that fails an integrity check, he notifies the server and the system enters a conflict resolution stage.

The server acquires the desired availability information concerning the peers from the certificates provided by the client, which are assumed to contain time stamp information.

A number of points are worth noting concerning the protocol defined by the sequence of transactions depicted in FIG. 3. First, the protocol is designed to record a commitment by both the client and the peer about their respective actions. Second, there is no way for the client to decrypt a file fragment without acknowledging to the server that the peer has responded to his request. Third, suppose a client maliciously claims to have received a corrupted packet from a peer. Then, since the client has committed to the keyed hash H(C, P_{E}) to the server, the server can verify his claim using the packet obtained from the peer. In this case, if the peer were honest and the client were to cheat, the client will be caught.

Another point to note is that the client cannot re-create the file fragment without committing that he received the fragments from the peers and, thus, he will not benefit by reporting that peers did not send him packets. Finally, if a peer has indeed provided a corrupted fragment, he will be caught because he has committed to the challenge H(C, P_{E}) via his certificate S_{P}. These certificates cannot be forged by the client since forging requires knowledge of the peer's secret key.

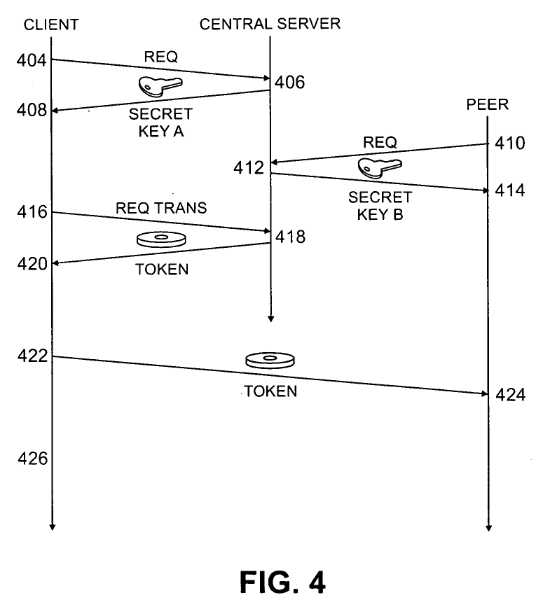

As previously mentioned, the protocol described above begins when the client requests and receives a ticket or token T from the server. While the ticket T may be provided in any appropriate manner, one illustrative approach will now be described with respect to FIG. 4, which shows another series of transactions along a timeline in the P2P system. In a peer-server transaction, the client formulates a request and sends it to a central server (event 404). In turn, the central server receives the request and sends a secret key (Secret Key A) to the client (event 406). This transaction terminates when the client receives Secret Key A (event 408). In another peer-server transaction, the peer formulates a request and sends it to a central server (event 410). In turn, the central server receives the request and sends a secret key (Secret Key B) to the peer (event 412). This transaction terminates when the peer receives Secret Key B (event 414). Accordingly, the client and peer each now possess their own secret key and a central server possesses a copy of each of these secret keys. Further, the central server stores each secret key in association with identifying information about its peer.

In yet another peer-server transaction, the client transmits a request to the central server (event 416). This request includes information about a desired transaction. For example, this request may specify “get file fragment xyz from the peer abc” or simply “get file fragment name xyz”. Where a request for a desired transaction identifies a peer, then the central server generates a token that includes security information for the identified peer. Where a request for a desired transaction does not identify a peer, but identifies, for example, a file name, then the central server may select a peer that has access to a file with that name (e.g., the peer has a data store that stores the file) and then generate a token that includes security information for the selected peer. Per event 418, the central server receives the request, generates a token and sends the token to the client that sent the request. Once the client receives the token (event 420), the client may initiate the desired peer-peer transaction by sending the token to the peer in event 422, which corresponds to event 306 shown in FIG. 3.

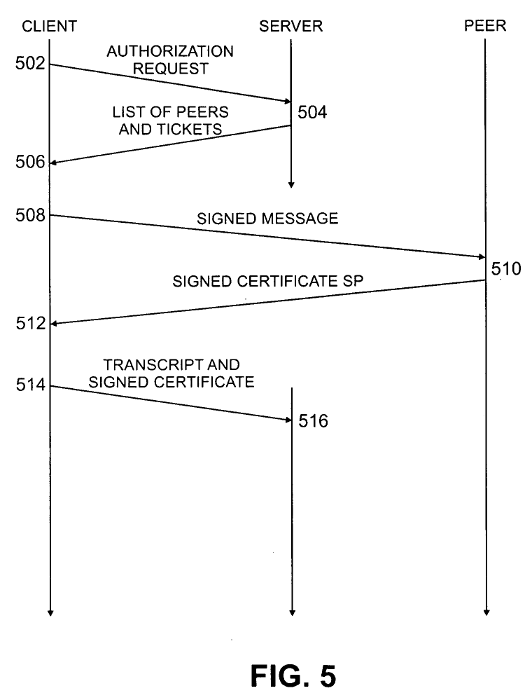

FIG. 5 shows a series of transactions along a timeline in the P2P illustrating one example of a protocol to upload a file fragment from the client to the peer. The protocol is similar to the download protocol shown in FIG. 3. In a client-server transaction, the client formulates a request to the server to authorize storage of file F (event 502). In response, the server grants access to upload the file F by sending the client a list of peers and tickets authorizing access to fragments (event 504). This transaction terminates when the client receives the list and tickets (event 506). In a series of client-peer transactions, the client sends a message to the peers signed with his private key (event 508). The message that is sent is <P_{F}, C, H(C, P_{F})T>, where P_{F} is a file fragment, C is a challenge, H(C, P_{F}) is a keyed hash function computed on the fragment and T is the ticket. Each peer may receive a different file fragment. The peer checks that the ticket T is correct and that H(C, P_{F}) is indeed the correct hash and sends back a signed certificate S_{P} to the client (event 510). The peer stores C,T and the message signature in its local hard drive or other storage medium. This client-peer transaction terminates when the client receives the signed certificate S_{F} (event 512). After the file fragments have been uploaded to the peers, it sends a transcript of the interactions, including the signed certificate, to the server (event 514). The server records which fragments are stored with which peers and also notes the availability of peers based on the time stamps on the certificates (event 516). The server may occasionally check with individual peers to confirm which file fragments they are storing. Any discrepancy between the peer's list of stored fragments and the server's corresponding list suggests that the client has failed to report the storage of a fragment. As a result, the system enters a conflict resolution stage.

A number of points are worth noting concerning the protocol described in connection with FIG. 5 to upload file fragments to peers. First, if an owner uploaded a Docket: 324749.01 fragment to a peer and did not report it to the server, the peer can prove to the server that it did get the fragment from the client by submitting the signed message and the packet that it received from the client. Second, if the client does not report the successful uploading of a file fragment, then when the time comes to recover the file fragment the server will not authorize recovery of the fragment from the peer for which the upload was not acknowledged. Finally, it should be noted that when the client sends the signed message during event 508, it also records an agreement between the client and the peer that the fragment was received intact.

1. A method for receiving access to a service in a peer-to-peer system, comprising:
requesting access to a service provisioned by a peer in a peer-to-peer network;
receiving access to the service provisioned by the peer; and
in order to make use of the accessed service, reporting to a central server that the service has been rendered.

2. The method of claim 1 wherein the service is off-site storage or processing capability.

3. The method of claim 1 wherein the service is off-site storage and access to the service includes receipt of a file fragment from the off-site storage.

4. The method of claim 3 wherein the file fragment is encrypted and further comprising, in response to reporting the rendering of the service, receiving a transaction key from the central server in order to decrypt the file fragment.

5. The method of claim 1 wherein reporting the rendered service to the server includes reporting a series of transactions between the peer and a client that receives the rendered service, wherein the transactions include challenges and responses that are certified with digital signatures.

6. The method of claim 3 further comprising:
sending a ticket to the peer indicting that access to the service is authorized by the central server;
receiving an encryption of the file fragment, wherein the file fragment is encrypted using a private key associated with the peer operating on the ticket;
sending a first digitally signed statement to the peer, wherein the signed statement includes a keyed hash of the encryption of the file fragment;
receiving a second digitally signed statement confirming that the keyed hash of the encryption of the file fragment is correct;
sending the first and second digitally signed statements to the central server; and
in response to sending the first and second digitally signed statements, receiving a decryption key to decrypted the encryption of the file fragment.

7. The method of claim 6 wherein the first and second digitally signed signatures are time stamped.

8. The method of claim 3 wherein the service is off-site storage and access to the service includes uploading a file fragment to the off-site storage.

9. The method of claim 8 further comprising:
requesting authorization from the central server to access the service;
in response to the request, receiving from the central server at least one ticket and a list of peers that offer to provision the service;
sending to a first of the peers on the list a message signed with a private key, wherein the message includes one of the tickets, the file fragment, a challenge and a keyed hash of the file fragment to be uploaded;
receiving from the first peer a signed statement certifying that the ticket is correct; and
sending the message and the signed statement to the central server.

10. A method of monitoring availability of a peer in a peer-to-peer system, comprising:
sending a ticket to a first peer that is requesting access to a service provisioned by a second peer in the peer-to-peer network;
receiving from the first peer statements digitally signed by the first and second peers demonstrating that the first peer successfully received access to the service; and
determining availability of the second peer using the digitally signed statements.

11. The method of claim 10 further comprising sending a transaction key to the first peer that is needed by the first peer to make use of the access to the service.

12. The method of claim 10 wherein the service is off-site storage or processing capability.

13. The method of claim 10 wherein the service is off-site storage and access to the service includes receipt of a file fragment from the off-site storage.

14. The method of claim 13 wherein the file fragment is encrypted and further comprising, in response to reporting the receipt of access, receiving a transaction key from the central server in order to decrypt the file fragment.

15. The method of claim 10 wherein the digitally signed statements include a report of a series of transactions between the first and second peers, wherein the transactions include challenges and responses that are certified with digital signatures.

16. At least one computer-readable medium encoded with instructions which, when executed by a processor, performs a method including:
verifying that a plurality of encrypted file fragments have been delivered to a respective plurality of recipient peers from a second peer in a peer-to-peer network that provides off-site storage for digital files associated with each of the peers;
in response to receipt of the verification, delivering a transaction key to each of the plurality of recipient peers which are needed to respectively decrypt the plurality of file fragments; and
measuring availability of the second peer based at least in part on a number of file fragments whose delivery to their respective recipient peers has been verified.

17. The computer-readable medium of claim 16 wherein verification of delivery of the plurality of encrypted file fragments is provided by each of the recipient peers.

18. The computer-readable medium of claim 17 wherein verification further comprising receiving a report from each of the recipient peers that describes a series of transactions between the respective receiving peer and the second peer, wherein the transactions include challenges and responses that are certified with digital signatures.

19. The computer-readable medium of claim 18 wherein the transactions are time-stamped.

20. The computer-readable medium of claim 16 wherein a different transaction key is associated with different recipient peers.
